(19) United States
(12) Patent Application Publication
(10) Pub. No.: US 2026/0175661 A1
(43) Pub. Date: Jun. 25, 2026

(54) SLIDING FOLDABLE PICKUP TRUCK TRUNK COVER

(71) Applicant: Foshan Shunde Heshengying Automotive Intelligent Technology Co., Ltd., Foshan City (CN)

(72) Inventors: Huiyang Wu, Foshan City (CN); Jintian Liang, Foshan City (CN); Guoqiang Mai, Foshan City (CN); Junlang Wu, Foshan City (CN)

(73) Assignee: Foshan Shunde Heshengying Automotive Intelligent Technology Co., Ltd., Foshan City (CN)

(21) Appl. No.: 19/021,114

(22) Filed: Jan. 14, 2025

(30) Foreign Application Priority Data
Dec. 19, 2024 (CN) 202411881485X

(51) Int. Cl. B60J 7/19; B60J 7/06

(52) U.S. Cl. CPC B60J 7/198; B60J 7/061

(57) ABSTRACT

This invention relates to a sliding foldable pickup truck trunk cover that comprises of mounting side plate installed on pickup truck trunk, several cover plates, the flip fold component between two adjacent cover plates; pulleys installed at both sides of bottom of cover plate; cover plate flip and lock components which are set at both sides of bottom of cover plate, in which, the bottom of one mounting side plate is fitted with cover plate slide and lock component. After the slide and lock component of cover plate, and the cover plate flip and lock component are unlocked, it can realize sliding and folding of trunk cover.

### TECHNICAL FIELD

This invention relates to a sliding foldable pickup truck trunk cover.

### BACKGROUND

As the pickup truck rear cover is rolling gate structure in general, storage chamber needs setting in pickup truck trunk for storing the gate, which reduces the storage space of trunk, increases the cost and results in blockage while opening/closing the gate.

### SUMMARY

A sliding foldable pickup truck trunk cover that overcomes the shortcomings of the existing techniques is provided in this invention.

The following technical schemes are used in this invention, in order to realize the purpose above.

A sliding foldable pickup truck trunk cover, which is characterized in that: Comprising mounting side plate installed on top face of the two lateral panels of pickup truck trunk; several cover plates, flip fold component which can flip and fold the front cover plate onto the trunk cover plate between two adjacent cover plates; pulleys, which can slide along with lateral mounting side plate, are installed at both sides of bottom of cover plate; cover plate flip and lock component, which is locked with the installation side boards at both sides to prevent the flip of cover plate to prevent flip of cover plate and can be unlocked, are set at both sides of bottom of cover plate, in which, the bottom of one mounting side plate is fitted with cover plate slide and lock component which can prevent sliding of the cover plate and can be unlocked.

As described above, the sliding foldable pickup truck trunk cover is characterized in that: The flip fold component includes middle connector, of which the front and rear sides are respectively connected to cover plate connector; besides, the middle connector can be folded into U-shape along with the cover plate connector at both sides; the lateral cover plates are respectively connected to the cover plate connector.

As described above, the sliding foldable pickup truck trunk cover is characterized in that: Three cover plates are set between the lateral mounting side plates; the width of middle connector in front flip and fold component is smaller than that of middle connector in the rear flip and fold component.

As described above, the sliding foldable pickup truck trunk cover is characterized in that: Mounting side plate chute, which is used for sliding the pulley, is set on the mounting side plate along length direction.

As described above, the sliding foldable pickup truck trunk cover is characterized in that: Mounting base is respectively set at both sides of bottom of cover plate, the pulley is set on the mounting base.

As described above, the sliding foldable pickup truck trunk cover is characterized in that: The outer limit flange, which is fitted with inner side of mounting side plate to prevent the pulley from leaving the mounting side plate, is installed on the mounting base; the limit chute is set along length direction of mounting plate; the mounting base is fitted with inner limit flange which is inserted in the limit chute to prevent the pulley from leaving the mounting side plate.

As described above, the sliding foldable pickup truck trunk cover is characterized in that: The cover plate flip and lock component is set on two mounting bases.

As described above, the sliding foldable pickup truck trunk cover is characterized in that: The cover plate flip and lock component includes the mounting base chute that is set on the mounting base; the mounting base chute is fitted with sliding block; the sliding block is fitted with buckle that is fastened with inner side of mounting side plate; the sliding block is connected with the flip and unlock connector that is inserted inwards to the mounting base; the flip and unlock rope is connected between the lateral flip and unlock connector; the cover plate front plate or the cover plate flip and lock component is fitted with flip and unlock handle that is set beyond on the flip and unlock rope and pulls both ends of flip and unlock rope inwards through rotation; the mounting base chute is fitted with flip and lock spring between the lateral side of mounting base chute and the sliding block, to fasten the top pressing sliding block and buckle, on the mounting side plate.

As described above, the sliding foldable pickup truck trunk cover is characterized in that: The front plate of cover plate or cover plate flip and lock component is fitted with multiple limit buckles, the flip and unlock ropes are set in the limit buckles respectively.

As described above, the sliding foldable pickup truck trunk cover is characterized in that: The mounting base is fitted with buckle that is fastened at the inner side of mounting side plate, the cover plate sliding and lock component includes the mounting bracket that is set at bottom of mounting side plate and close to one buckle; the mounting bracket is fitted with buckle and the cover plate sliding and lock component that can prevent sliding of cover plate and can be rotated and unlocked; the slide and unlock handle that can rotate is set at the bottom and front side of cover plate; the sliding and unlock rope is set between the sliding and unlock handle and cover plate sliding and lock component; the sliding and lock spring that can reset the cover plate sliding and lock component and lock the buckle, is set between the mounting bracket and cover plate sliding and lock component.

Beneficial effects of this invention:
Several cover plates are set in this invention. The pulleys for sliding the cover plate on the lateral mounting side plates are set at the bottom of cover plate. The cover plate flip and lock component, which can prevent flip of cover plate and can be unlocked, are set between the adjacent cover plates and fastened with the lateral mounting side plates, in which, the bottom of one mounting side plate is fitted with cover plate slide and lock component which can prevent sliding of the cover plate and can be unlocked. After the slide and lock component of cover plate is unlocked, the cover plate can slide outwards along with the mounting side plate; after the cover plate flip and lock component is unlocked, the front cover plate can be flipped and folded on the rear cover plate, to realize sliding and folding function of trunk cover, have easy assembly and disassembly without occupying the space of car pocket, thus increasing the space of trunk and reducing the cost; meanwhile, the folding process is smooth; the cover plate and be folded or unfolded by one person to have easy and convenient operation.

### BRIEF DESCRIPTION OF THE DRAWINGS

FIG. 1 is the structure schematic diagram 1 of this invention;

FIG. 2 is the breakdown diagram 1 of this invention;

FIG. 3 is the breakdown diagram 2 of this invention;

FIG. 4 is the schematic diagram 2 of this invention;

FIG. 5 is the breakdown diagram 3 of this invention;

FIG. 6 is the enlarged diagram of Part A in FIG. 5;

FIG. 7 is schematic diagram 3 of this invention;

FIG. 8 is the enlarged diagram of Part B in FIG. 7.

### DETAILED DESCRIPTIONS OF THE EMBODIMENTS

The technical schemes in implementation cases of this invention are described clearly and completely by combining the attached diagrams below.

It should be noted that all directional indications (such as up, down, left, right, front, back . . . ) in the implementation cases of this invention explain the relative position relationship and movement conditions between all parts under certain gesture (as shown in the attached diagram), and the directional indications will change accordingly when the specific gesture is changed. Besides, the “preference” and “less preference” in this invention are for description only and shall not be understood as quantity that indicates or implies the relative importance or implies the technical characteristics. Therefore, the characteristics of “preference” and “less preference” can include at least one such characteristic explicitly or implicitly.

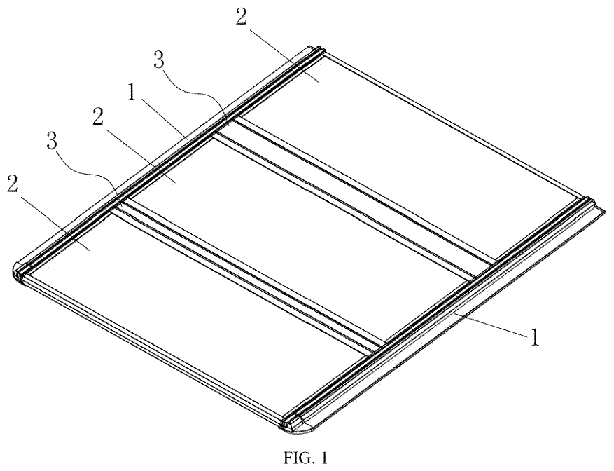

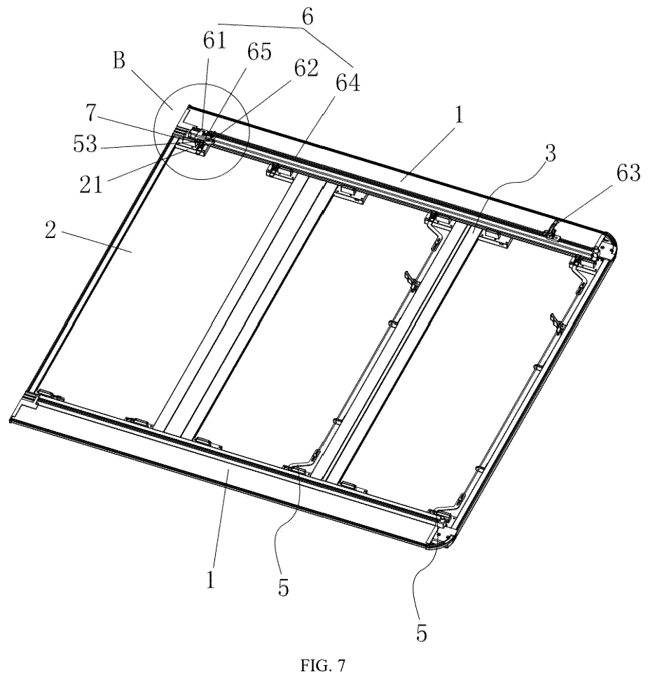

As shown in FIG. 1-8, it is a sliding foldable pickup truck trunk cover comprising of mounting side plate 1 and several cover plates 2 on the top face at lateral panels of pickup truck trunk; the flip and fold component 3, which can flip and fold the cover plate 2 onto the rear cover plate 2, is set between the adjacent cover plates 2; the pulley 4 which can slide along with lateral mounting side plate 1, is respectively set at both sides of the bottom of cover plate 2; cover plate flip and lock component 5, which is fastened with lateral mounting plate 1 and can prevent flip of the cover plate 2 and can be unlocked, are set at both sides of the bottom of cover plate 2, in which, the bottom of one mounting side plate 1 is fitted with cover plate slide and lock component 6 which can prevent sliding of the cover plate 2 and can be unlocked. During actual folding, firstly unlock the sliding and unlock component 6 of the cover plate, to slide the cover plate 2 outwards along with lateral mounting plate 1 under the action of pulley 4; after the front cover plate slides out the mounting side plate 1, unlock the cover plate fold and lock component 5 of this cover plate 1, to flip this cover plate backwards onto the rear and adjacent cover plates, then slide out the rear cover plate; after the rear cover plate slides out the mounting side plate 1, unlock the cover plate flip and lock component 5 of this cover plate, to flip this cover plate and the folded cover plate backwards to the rear and adjacent cover plate, and the rest can be analogized in the same manner, until the front cover plate is folded onto the final cover plate to complete folding. In particular, part of the front cover plate can be folded in actual operation as required. Likewise, when opening the folded cover plate, push the folded cover plate inwards and rotate them reversely to open them in turns; while rotating and opening the cover plate, reset the cover plate flip and lock component 5 to lock the cover plate on lateral mounting side plate 1; after opening the final cover plate, use the cover plate slide and lock component 6 to fix the opened trunk cover on mounting side plate 1, to prevent the sliding of this trunk cover. Meanwhile, the cover plate can be folded or unfolded by one person, to realize easy and convenient operation, avoid the space of rolling gate, increase the storage space of trunk and reduce the production cost.

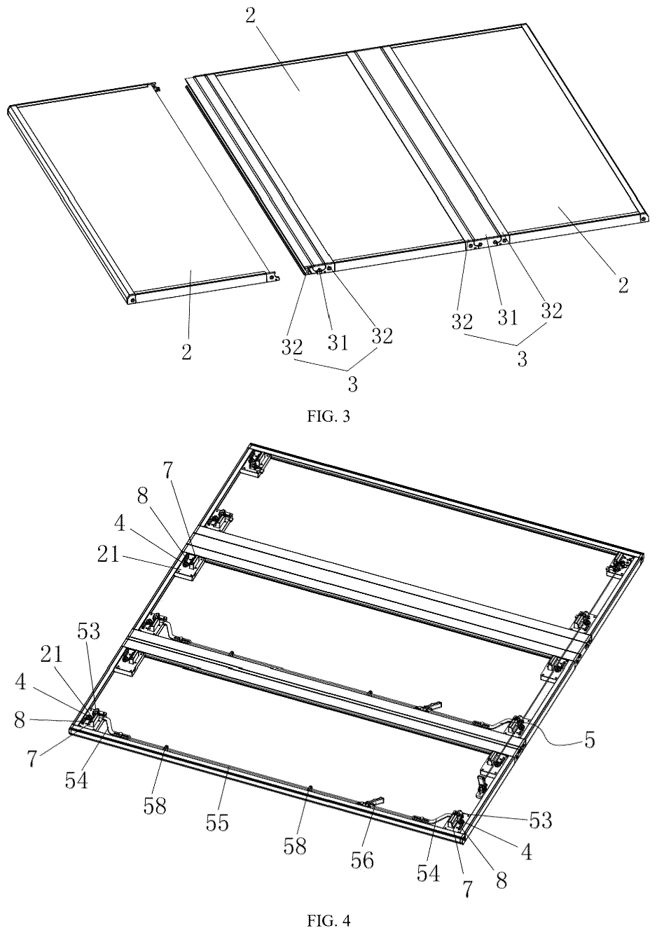

As shown in FIG. 3, the flip fold component 3 includes middle connector 31, of which the front and rear sides 31 are respectively connected to cover plate connector 32; besides, the middle connector 31 can be folded into U-shape along with the cover plate connector 32 at both sides; the lateral cover plates 2 are respectively connected to the cover plate connector 32. Three cover plates 2 are set between the lateral mounting side plates 1; the width of middle connector 31 in front flip and fold component 3 is smaller than that of middle connector 31 in the rear flip and fold component 3. During folding in this scheme, the cover plate connector 32 that connects front cover plate will also rotate along with the middle connector 31 while the front cover plate flips to the rear cover plate; meanwhile, the middle connector 31 will rotate along with the rear cover plate connector 32, so the front cover plate and the connected cover plate connector 32 will flip and fold on the rear cover plate, to realize the rotation and fold function of cover plate.

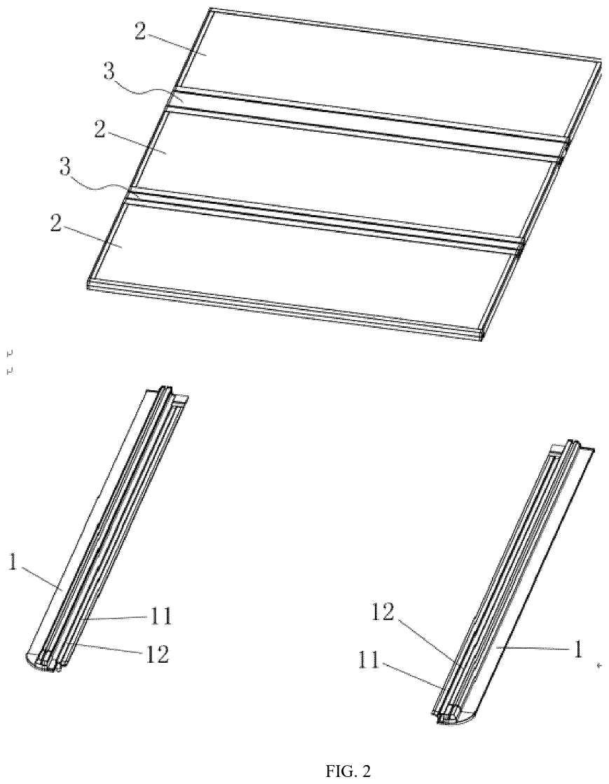

As shown in FIG. 2, the mounting side plate is fitted with mounting plate chute 11 for sliding the pulley 4 along with length direction, to ensure better sliding of cover plate 2 on mounting plate 1.

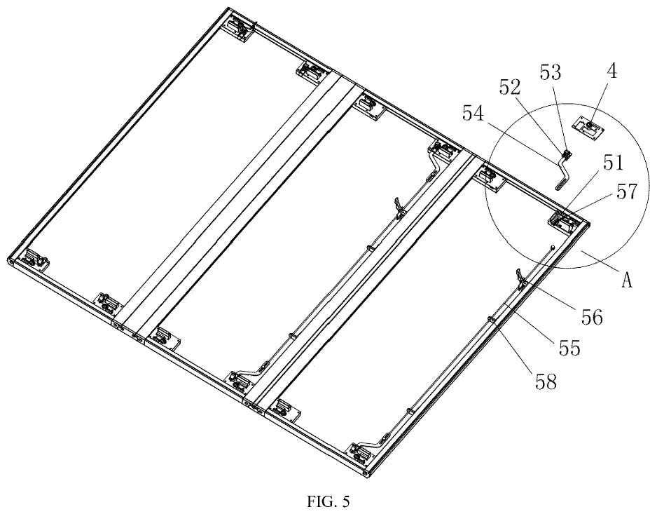

As shown in FIG. 4, mounting base 21 is respectively set at both sides of bottom of cover plate 2, the pulley 4 is set on mounting base 21, to install the pulley 4 easily.

As shown in FIG. 2 and FIG. 4, the outer limit flange 7, which is fitted with inner side of mounting side plate 1 to prevent the pulley 4 from leaving the mounting side plate 1, is installed on the mounting base 21; the limit chute 12 is set along length direction of mounting plate 1; the mounting base 21 is fitted with inner limit flange 8 which is inserted in the limit chute 12 to prevent the pulley 4 from leaving the mounting side plate 1. The pulley 4 on limit cover plate 2 slides on the mounting side plate chute 11 on mounting plate 1, to prevent the pulley 4 from leaving the mounting side plate chute 11.

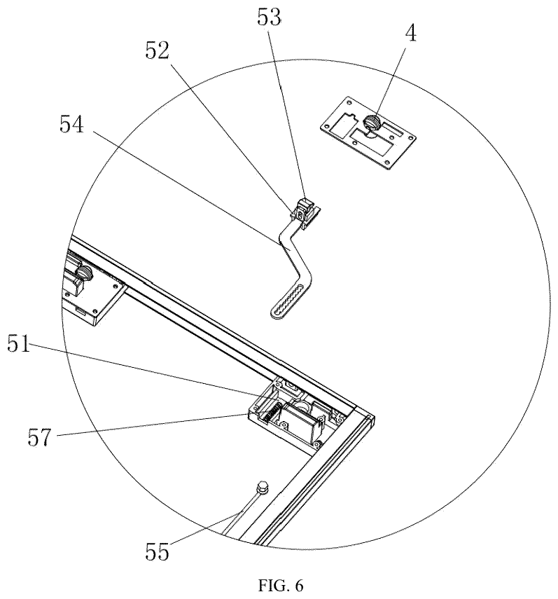

As shown in FIG. 4-6, the cover plate flip and lock component 5 is set on two mounting bases 21; the cover plate flip and lock component 5 includes the mounting base chute 51 on the mounting base 21; the mounting base chute 51 is fitted with sliding block 52; the sliding block 52 is fitted with buckle 53 that is fastened with the inner side of mounting side plate 1; the sliding block 52 is connected with flip and unlock connector 54 that is inserted to mounting base 21; the flip and unlock rope 55 is connected between the lateral flip and unlock connector 54; the cover plate 2 front plate or the cover plate flip and lock component 5 is fitted with flip and unlock handle 56 that is set beyond the flip and unlock rope 55 and pulls both ends of flip and unlock rope 55 inwards through rotation; the mounting base chute 51 is fitted with flip and lock spring 57 between the lateral side of mounting base chute 51 and the sliding block 52, to fasten the top pressing sliding block 52 and buckle 53 on the mounting side plate 1. The cover plate flip and lock component 5 can be unlocked by rotating the flip and unlock handle 56; then, the flip and unlock handle 56 will drive the flip and unlock both ends of rope 55 to have inward pulling, thus pulling the flip and unlock connector 54 to have motion inwards, the buckle 53 and sliding block 52 will slide inwards along with mounting base chute 51, so the buckle 53 will leave the lateral side of mounting side plate 1 to realize unlock. Likewise, loosen the flip and unlock handle 56 under lock status, to push the sliding block 52 and buckle 53 to slide outwards along with mounting base chute 51 under the elastic action of flip and lock spring 57, thus fastening the buckle 53 at the side of mounting side plate 1 and realizing locking. As shown in FIG. 4-5, the front plate of cover plate 2 or cover plate flip and lock component 5 is fitted with multiple limit buckles 58, the flip and unlock ropes 55 are set in the limit buckles 58 respectively, to restrict the pulling direction of flip and unlock rope 55, in order to save energy while rotating flip and unlock handle 56, and accurately pull the sliding block 52 inwards along with the mounting base chute 51.

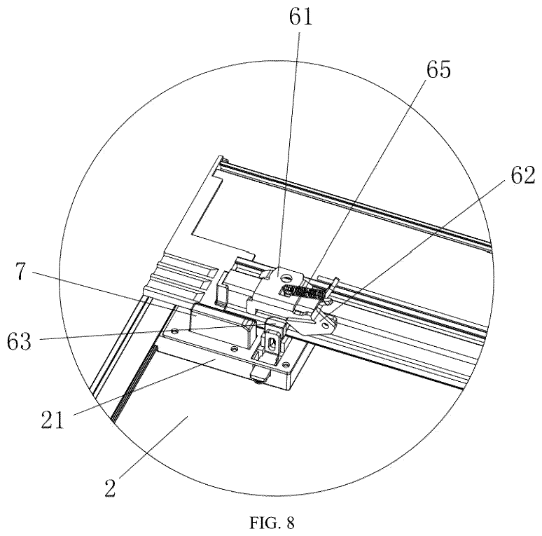

As shown in FIG. 7-8, the mounting base 21 is fitted with buckle 53 that is fastened at the inner side of mounting side plate 1, the cover plate sliding and lock component 6 includes the mounting bracket 61 that is set at bottom of mounting side plate 1 and close to one buckle 53; the mounting bracket 61 is fitted with buckle 53 and the cover plate sliding and lock component 62 that can prevent sliding of cover plate and can be rotated and unlocked; the slide and unlock handle 63 that can rotate is set at the bottom and front side of cover plate 2; the sliding and unlock rope 64 is set between the sliding and unlock handle 63 and cover plate sliding and lock component 62; the sliding and lock spring 65 that can reset the cover plate sliding and lock component 62 and lock the buckle 53, is set between the mounting bracket 61 and cover plate sliding and lock component 62. While unlocking the cover plate sliding and lock component 6, rotate the sliding and unlock handle 63 for unlocking, the sliding and unlock rope 64 will pull the cover plate sliding and unlock part 62 to rotate along with the mounting bracket, thus separating the cover plate sliding and unlocking part 62 from buckle 53 and realizing unlocking, so the cover plate can slide outwards along with mounting plate; when sliding and unlock handle 63 is loosened, the cover plate sliding and lock part 62 will rotate along with mounting bracket 61 under the action of sliding and lock spring 65, to realize reset. Meanwhile, locking can be realized by pushing the cover plate inwards and connecting the cover plate sliding and lock part 62, which is rotated and reset, to the buckle 53.

The contents above are preferred implementation cases of this invention and do not restrict the patent range of this invention. All equivalent structure changes in this invention specification and attached diagrams under the conception of this invention, or direct or indirect application in other relevant technical fields, are within the protection scope of this invention.

What is claimed is:

1. A sliding foldable pickup truck trunk cover, which is characterized in that: Comprising mounting side plate (1) installed on top face of the two lateral panels of pickup truck trunk; several cover plates (2), flip fold component (3) which can flip and fold the front cover plate (2) onto the trunk cover plate (2) between the adjacent cover plates (2); pulleys (4), which can slide along with lateral mounting side plate (1), are installed at both sides of bottom of cover plate (2); cover plate flip and lock component (5), which is locked with the installation side boards (1) at both sides to prevent the flip of cover plate (2) and can be unlocked, are set at both sides of bottom of cover plate (2), in which, the bottom of one mounting side plate (1) is fitted with cover plate slide and lock component (6) which can prevent sliding of the cover plate (2) and can be unlocked.

2. As described in claims 1, the sliding foldable pickup truck trunk cover is characterized in that: The flip fold component (3) includes middle connector (31), of which the front and rear sides (31) are respectively connected to cover plate connector (32); besides, the middle connector (31) can be folded into U-shape along with the cover plate connector (32) at both sides; the lateral cover plates (2) are respectively connected to the cover plate connector (32).

3. As described in claims 2, the sliding foldable pickup truck trunk cover is characterized in that: Three cover plates (2) are set between the lateral mounting side plates (1); the width of middle connector (31) in front flip and fold component (3) is smaller than that of middle connector (31) in the rear flip and fold component (3).

4. As described in claims 1, the sliding foldable pickup truck trunk cover is characterized in that: Mounting side plate chute (11), which is used for sliding the pulley (4), is set on the mounting side plate (1) along length direction.

5. As described in claims 1, the sliding foldable pickup truck trunk cover is characterized in that: Mounting base (21) is respectively set at both sides of bottom of cover plate (2), the pulley (4) is set on the mounting base (21).

6. As described in claims 5, the sliding foldable pickup truck trunk cover is characterized in that: The outer limit flange (7), which is fitted with inner side of mounting side plate (1) to prevent the pulley (4) from leaving the mounting side plate (1), is installed on the mounting base (21); the limit chute (12) is set along length direction of mounting plate (1); the mounting base (21) is fitted with inner limit flange (8) which is inserted in the limit chute (12) to prevent the pulley (4) from leaving the mounting side plate (1).
